(19) United States
(12) Patent Application Publication
(10) Pub. No.: US 2002/0055336 A1
(43) Pub. Date: May 9, 2002

(54) Antenna module for cellular phone with two helix antennas

(76) Inventor: Soo Won Hong, Seoul (KR)

Correspondence Address: BACON & THOMAS, PLLC, 625 Slaters Lane, 4th Floor, Alexandria, VA, 22314-1176, US

(21) Appl. No.: 09/737,491

(22) Filed: Dec. 18, 2000

(30) Foreign Application Priority Data
Sep. 30, 2000 (KR) 2000-57751
Sep. 30, 2000 (KR) 2000-57752
Sep. 30, 2000 (KR) 2000-57753

(51) Int. Cl. H04B 1/06

(52) U.S. Cl. 455/90; 455/272; 343/702

(57) ABSTRACT

An antenna module for a cellular phone which is capable of minimizing the effect of electromagnetic radiation of the cellular phone on the human body and enhancing the quality of speech of the cellular phone. The antenna module comprises two helix antennas installed in the cellular phone transversally apart from each other, and a power supply unit connected to the helix antennas for applying two power signals with the same power level and opposite phases respectively to the helix antennas. This antenna module is able to radiate a minimized amount of electromagnetic waves in the longitudinal direction of the cellular phone, or toward either the top or rear part of the cellular phone, and an increased amount of electromagnetic waves in the transversal direction of the cellular phone, respectively, thereby minimizing electromagnetic radiation to the human body while at the same time enhancing the quality of speech of the cellular phone.

### BACKGROUND OF THE INVENTION

1. Field of the Invention

The present invention relates in general to antennas for cellular phones, and more particularly to an antenna module for a cellular phone in which two helix antennas are installed in the cellular phone at a predetermined distance from each other and two power signals with the same power level and opposite phases are applied respectively to the helix antennas to control an electromagnetic radiation pattern thereof, thereby minimizing the antenna effect on the human body, enhancing the quality of speech and reducing a specific absorption rate (SAR).

2. Description of the Prior Art

Owing to the rapid development of radio communication and the increasing use of electronic and electrical equipment, the human body has recently been increasingly exposed to intended electromagnetic radiation and undesired electromagnetic radiation. In particular, because cellular phones are used close to the human body differently from other communication equipment, most users have a vague fear that they could suffer relatively heavy physical harm from the cellular phones.

In order to reflect such concerns, there have been provided the “human body protection criteria on electromagnetic field exposure”, the contents of which agree closely with those of International Commission on Non-Ionizing Radiation Protection (ICNIRP), which is the strictest standard throughout the world. Similarly in U.S.A., this electromagnetic radiation has also become a critical issue and several states and private organizations have thus announced standards based on their own data. Among these standards, ones announced by Institute of Electrical and Electronics Engineers (IEEE) and American National Standards Institute (ANSI) have been accepted by Federal Communications Commission (FCC) and some items thereof have thus been enforced since 1997.

A local electromagnetic wave specific absorption rate (SAR), which is defined as the amount of energy accumulated in the human body per unit mass or unit time, is applied for safety evaluation of cellular phones and similar portable equipment used close to the human head. The local electromagnetic wave SAR is calculated based on an area exposed to electromagnetic radiation, namely, it may be an electromagnetic wave SAR averaged over 1 gram or 10 grams of the human body. This electromagnetic wave SAR is basically defined differently by two international standards. For one standard, countries having enforced regulations, such as U.S.A., Canada, Australia, etc., require that an electromagnetic wave SAR averaged over 1 gram of the human body should be below 1.6 W/kg. For the other standard, ICNIRP, Europe, Japan, etc. recommend that an electromagnetic wave SAR averaged over 10 grams of the human body should be below 2W/kg. In either standard, the same measurement procedure is performed.

Almost all cellular phones currently used throughout the world generally comprise isotropic (omnidirectional) antennas projected from their right or left top portions and each having a helix and wheep, as shown in FIG. 1. Such an isotropic antenna cannot help radiating electromagnetic waves to the human head during a call over the cellular phone due to its inherent property. In this regard, it is the current reality that cellular phone and antenna manufacturing companies prominent throughout the world have developed antennas with a new concept of radiating no electromagnetic wave to the human head at a great cost and labor.

One approach to such antennas is an antenna which is capable of, when a cellular phone is in use, radiating a small amount of electromagnetic waves toward the front part of the cellular phone held close to the human head and most of the electromagnetic waves toward the rear part of the cellular phone, respectively. This antenna may be, for example, a patch antenna, PFIA antenna and etc. mounted on the top of the rear part of a cellular phone, which are now being studied and some of which have reached the practical use phase.

However, approval organizations of FCC concerned with the SAR issues have recently added a clause requiring that the rear part of a cellular phone be brought into close contact with a simulated human breast and a measurement be made of the SAR under this condition, in consideration of cellular phone call situations under the condition that the cellular phone is held in a user's shirt pocket as well as under the condition that the front part of the cellular phone is held close to the user's head.

As a result, a patch antenna or PFIA antenna devised to radiate a small amount of electromagnetic waves toward the front part of a cellular phone and most of the electromagnetic waves toward the rear part of the cellular phone, respectively, will violate the above-added clause. That is, the patch antenna or PFIA antenna is desirable to reduce the electromagnetic radiation toward the front part of the cellular phone, but has a disadvantage in that it increases the electromagnetic radiation toward the rear part of the cellular phone, thereby causing a user to suffer a heavy exposure to the electromagnetic radiation when he or she conducts a conversation over the cellular phone while holding it in his or her pocket. Hence, there is a keen need for the development of an antenna for a cellular phone capable of minimizing damage resulting from electromagnetic radiation on the human body while assuring the quality of speech of the cellular phone.

### SUMMARY OF THE INVENTION

Therefore, the present invention has been made in view of the above problems, and it is an object of the present invention to provide an antenna module for a cellular phone in which two helix antennas are installed in the cellular phone at a predetermined distance from each other and two power signals with the same power level and opposite phases are applied respectively to the helix antennas.

It is another object of the present invention to provide an antenna module for a cellular phone with two helix antennas which is capable of controlling an electromagnetic radiation pattern of the two helix antennas using two power signals applied respectively to the helix antennas in such a manner that transversal radiation is increased and longitudinal radiation, or electromagnetic radiation toward either the front part or rear part of the cellular phone, can be reduced, thereby minimizing the electromagnetic effect on the human body, enhancing the quality of speech and reducing a specific absorption rate (SAR).

In accordance with the present invention, the above and other objects can be accomplished by a provision of an antenna module for a cellular phone, comprising two helix antennas installed in the cellular phone transversally apart from each other; and power supply means connected to the helix antennas for applying two power signals respectively to the helix antennas, the power signals having the same power level and opposite phases.

Preferably, the helix antennas may have opposite helical directions such that they have opposite phases while remaining matched with each other.

Alternatively, the helix antennas may have the same helical direction.

Preferably, the power supply means may include a divider for receiving a power signal from a feeding point and dividing it equally into the above two power signals in two different directions; two transmission lines divided by the divider in the two different directions for transmitting the two power signals from the divider respectively to the two helical antennas; and two helix couplers formed respectively at ends of the two transmission lines and coupled respectively with the two helix antennas for applying the two power signals transmitted respectively over the two transmission lines respectively to the two helix antennas. Here, the two transmission lines may be symmetrical with each other.

Alternatively, the power supply means may include a divider for receiving a power signal from a feeding point and dividing it equally into the two power signals in two different directions; two transmission lines divided by the divider in the two different directions for transmitting the two power signals from the divider respectively to the two helical antennas; and a λ/2 delay line or phase shifter connected to one of the two transmission lines for delaying a phase of the power signal transmitted over the connected transmission line.

Therefore, the present antenna module is able to radiate a minimized amount of electromagnetic waves in the longitudinal direction of the cellular phone, or toward either the top or rear part of the cellular phone, and an increased amount of electromagnetic waves in the transversal direction of the cellular phone, respectively, so as to minimize electromagnetic radiation to the human body while at the same time enhancing the quality of speech of the cellular phone.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a cellular phone having a conventional antenna;

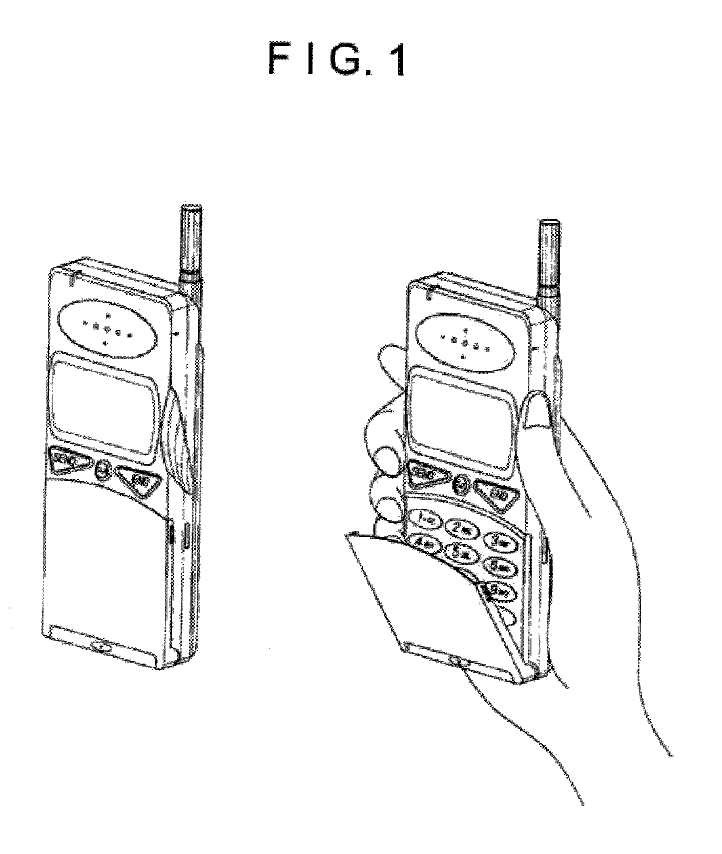

FIG. 2 is a view showing a radiation pattern of point sources with opposite phases in accordance with the present invention;

FIG. 3 is a view showing a structure of a helix antenna according to the present invention and its equivalent structure;

FIG. 4 is a view showing the construction of a printed circuit board (PCB) on which a power supply unit is formed in accordance with a first embodiment of the present invention;

FIG. 5 is a view showing structures of two helix antennas according to the first embodiment of the present invention and their equivalent structures;

FIG. 6 is a plan view of a radiation pattern formed by two helix antennas in accordance with the present invention;

FIG. 7 is a view showing the arrangement of a PCB in a cellular phone in accordance with the first embodiment and a third embodiment of the present invention;

FIG. 8 is a view showing the arrangement of a PCB in an antenna housing mounted to a cellular phone in accordance with the first and third embodiments of the present invention, wherein the PCB is integrated with the antenna housing through a molding process and the antenna housing is thereafter mounted to the cellular phone;

FIG. 9 is a view showing the arrangement of helix antennas with an increasing pitch in a cellular phone in accordance with the first and third embodiments of the present invention;

FIG. 10 is a view showing the arrangement of helix antennas with an increasing radius in a cellular phone in accordance with the first and third embodiments of the present invention;

FIG. 11 is a view showing the construction of a PCB on which a λ/2 delay line is formed in accordance with a second embodiment and the third embodiment of the present invention;

FIG. 12 is a view showing the construction of a PCB on which a phase shifter is formed in accordance with the second and third embodiments of the present invention;

FIG. 13 is a view showing structures of two helix antennas according to the second embodiment of the present invention and their equivalent structures;

FIG. 14 a view showing the arrangement of a PCB in a cellular phone in accordance with the second embodiment of the present invention;

FIG. 15 is a view showing the arrangement of a PCB in an antenna housing mounted to a cellular phone in accordance with the second embodiment of the present invention, wherein the PCB is integrated with the antenna housing through a molding process and the antenna housing is thereafter mounted to the cellular phone;

FIG. 16 is a view showing the arrangement of helix antennas with an increasing pitch in a cellular phone in accordance with the second embodiment of the present invention;

FIG. 17 is a view showing the arrangement of helix antennas with an increasing radius in a cellular phone in accordance with the second embodiment of the present invention; and

FIG. 18 is a view showing structures of two helix antennas according to the third embodiment of the present invention and their equivalent structures.

### DETAILED DESCRIPTION OF THE PREFERRED EMBODIMENTS

In the present invention, an antenna module for a cellular phone basically comprises two helix antennas and a power supply unit. The power supply unit is adapted to apply two power signals with the same power level and opposite phases respectively to the two helix antennas, thereby supplying the same amount of power respectively to the two antennas. Therefore, the helix antennas of the cellular phone radiate a reduced amount of electromagnetic waves in the longitudinal direction of the cellular phone, or toward the top of the cellular phone, and an increased amount of electromagnetic waves in the transversal direction of the cellular phone, respectively, thereby minimizing the amount of electromagnetic radiation directed toward the human body while at the same time enhancing the quality of speech of the cellular phone.

First, consider whether such an antenna module is theoretically possible, before describing this invention.

It is next to impossible to form the above radiation pattern with one antenna as in the prior art. As a result, two antennas must be considered.

The theoretical conditions enabling two antennas with the same characteristics to radiate a small amount of electromagnetic waves in the longitudinal direction and most of the electromagnetic waves in the transversal direction (in the antenna array direction), respectively, are as follows.

If two signals applied respectively to the two antennas are the same in power level and opposite in phase, the following equation can be defined:

$$AF = - {le}^{- j β ( d / 2 ) cos θ} + {le}^{j β ( d / 2 ) cos θ} = 2 j sin ( β \frac{d}{2} cos θ ) \qquad [ Equation 1 ]$$

In the above equation 1, “AF” is an array factor, “d” is a distance between the two antennas and “θ” is an angle of the origin to a measured point. For example, assuming that the two antennas are apart from each other at a distance of λ/4 of a frequency of a cellular phone, the above equation 1 can be normalized as in the below equation 2 by substituting βwith 2π/λand d with λ/4 , respectively.

$$f ( θ ) = sin ( \frac{π}{4} cos θ ) \qquad [ Equation 2 ]$$

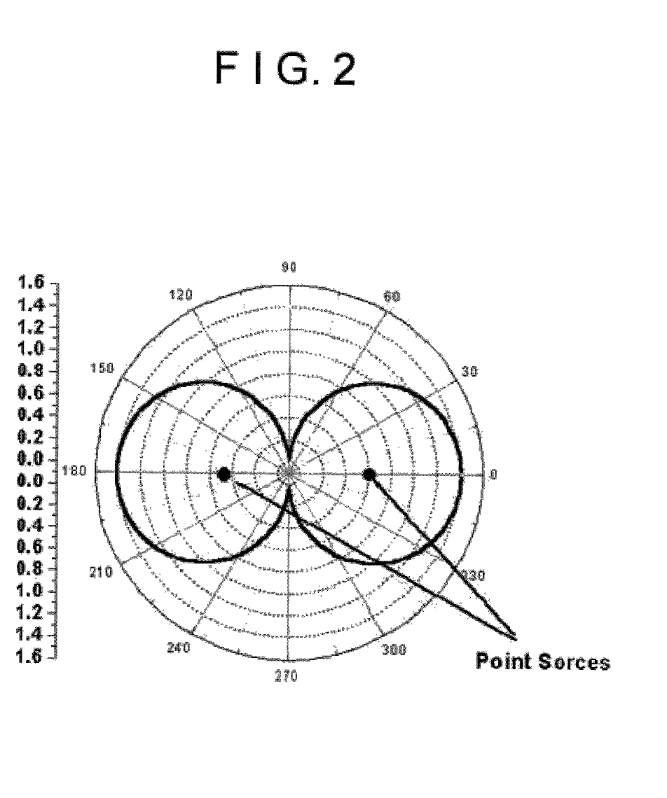

A radiation pattern based on the above equation 2 can be depicted as in FIG. 2.

As shown in FIG. 2, most electromagnetic radiation is generated in the transversal direction and little electromagnetic radiation is generated in the longitudinal direction. But, this radiation pattern will be slightly different from an actual radiation pattern because of influences of the cellular phone body and different point sources. In other words, the radiation pattern of FIG. 2 is a theoretical model taking the antennas simply as point sources, and the actual radiation pattern will be formed in consideration of influences of the cellular phone body as well as the fundamental size of the antennas. At any rate, it is proven that the present antenna module is theoretically possible.

Next, consider the fundamental characteristics of the helix antennas to deduce a radiation pattern thereof.

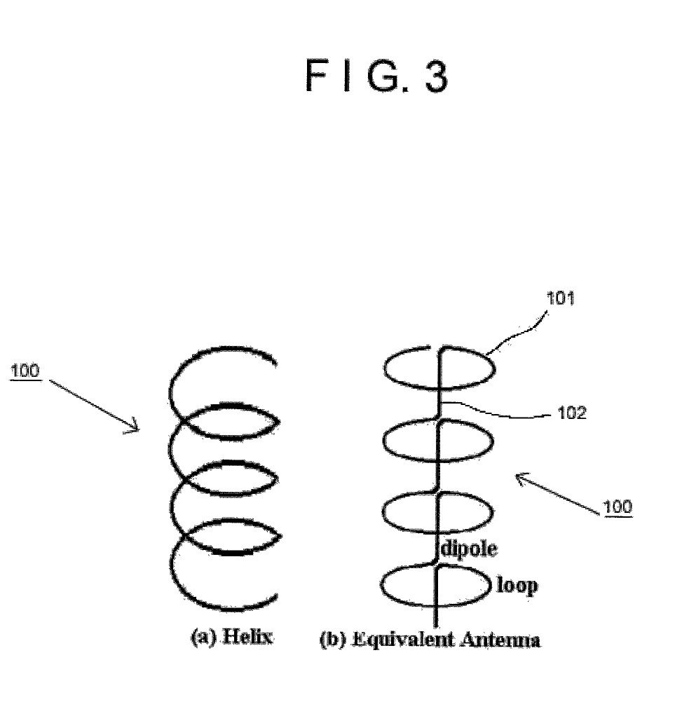

In FIG. 3, an equivalent structure of each helix antenna 100 can be interpreted to have successive combinations of loop antennas 101 and dipole antennas 102.

Then, how to realize two power signals to the two helix antennas 100 of the cellular phone, having the same power level and opposite phases, becomes an issue.

Hereinafter, the present invention will be described in detail on the basis of three embodiments.

### <EMBODIMENT 1>

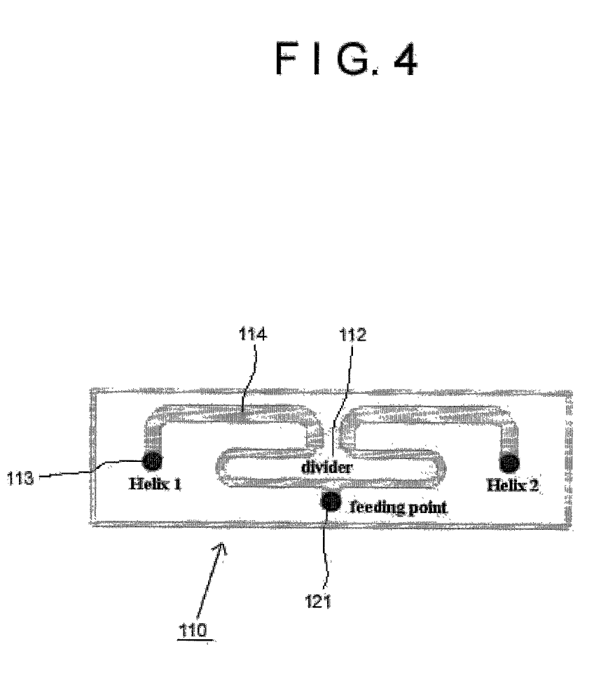

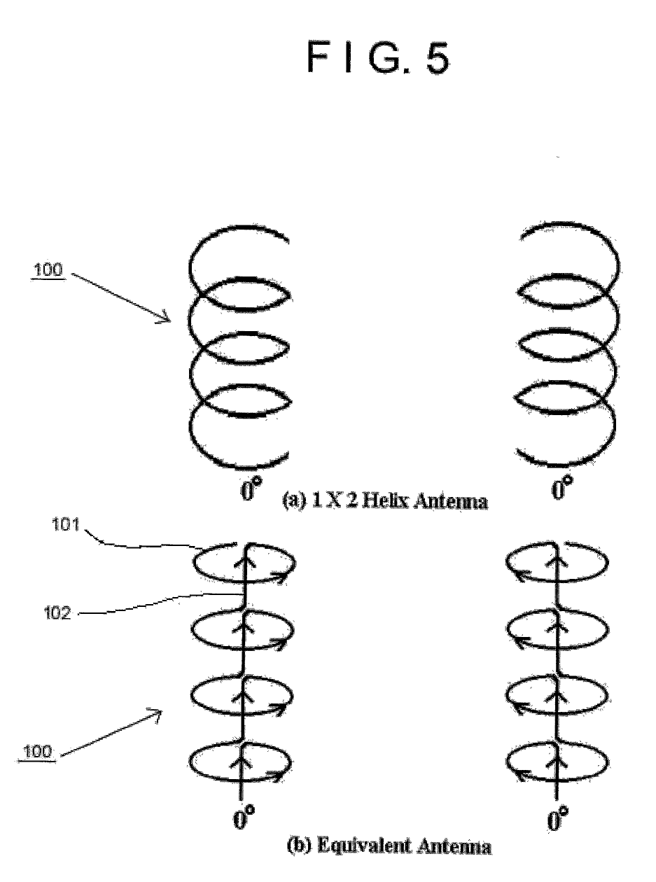

In a first embodiment of the present invention, as shown in FIGS. 4 and 5, a power signal of 50Ω is applied to a feeding point 121 formed on a printed circuit board (PCB) 120, and then matched with two identical helix antennas 100 at opposite phases. To this end, two helix antennas 100 with opposite helical directions and a power supply unit 110 are used.

The two helix antennas 100 are respectively coupled with helix couplers 113 formed on the PCB 120, as will be described later, in such a manner that they have opposite helical directions and are set apart at a predetermined distance from each other.

Because the two helix antennas 100 have opposite helical directions, their equivalent structures can be interpreted to have successive arrays of loop antennas 101 and dipole antennas 102. Because the current flow directions of the loop antennas 101 of the two helix antennas 100 are opposite to each other, radiation components of the loop antennas 101 offset each other at an intermediate point of the helix antennas 100 and overlap each other outward from the helix antennas 100, or in the transversal direction. As a result, the transversal radiation is increased while the longitudinal radiation is minimized.

Radiation components of the dipole antennas 102 are unchanged at the intermediate point of the helix antennas 100.

The power supply unit 110 is adapted to supply the same amount of current respectively to the two helix antennas 100. To this end, the power supply unit 110 basically includes a divider 112, two transmission lines 114 and two helix couplers 113 formed on the PCB 120.

The divider 112 is electrically connected to the feeding point 121, which is in turn connected to a feeding point of the cellular phone to receive the power signal of 50Ω therefrom. Upon receiving the power signal from the feeding point 121, the divider 112 divides it equally and supplies the resulting two power signals respectively to the two transmission lines 114, as will be described later.

The two transmission lines 114 are symmetrically divided at the divider 112 and connected respectively to the helix couplers 113 at their ends to transmit the power signals with the same power level from the divider 112 thereto. The helix couplers 113 are coupled respectively with the helix antennas 100 to receive the power signals with the same power level from the divider 112 over the transmission lines 114 and apply them to the helix antennas 100.

Namely, the helix couplers 113 are connected respectively to the ends of the transmission lines 114 to receive the power signals with the same power level from the divider 112 and coupled respectively with the helix antennas 100 to apply the received power signals thereto.

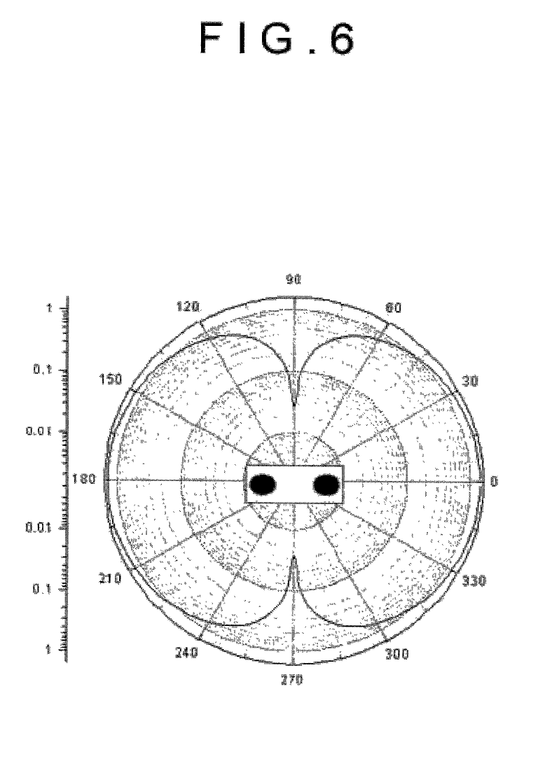

Then, the helix antennas 100 radiate electromagnetic waves in response to the power signals from the helix couplers 113, as stated above. At this time, an electromagnetic radiation pattern as shown in FIG. 6 is formed in which electromagnetic waves offset each other between the helix antennas 100 of the cellular phone and increase in amount in the transversal direction of the cellular phone.

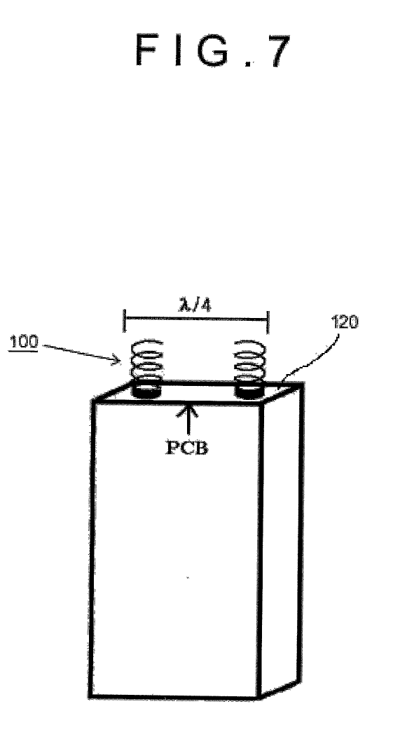

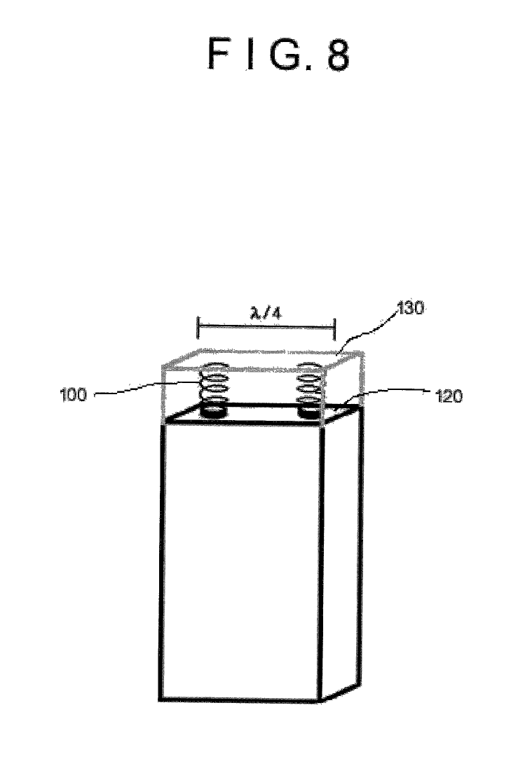

The PCB 120 having the power supply unit 110 formed thereon must be coupled with the cellular phone under the condition that it is coupled with the helix antennas 100. The PCB 120 can be coupled with the cellular phone by connecting its feeding point 121 to the feeding point of the cellular phone. Namely, the PCB 120 can be closely mounted to the top surface or bottom surface of the cellular phone as shown in FIG. 7. Alternatively, the PCB 120 having the helix antennas 100 installed therein may be integrated with an antenna housing 130 through a molding process and the antenna housing 130 may thereafter be mounted to the top surface or bottom surface of the cellular phone, as shown in FIG. 8.

That is, the PCB 120 equipped with the helix antennas 100 is mounted to the top surface or bottom surface of the cellular phone under the condition that it is integrated with the antenna housing 130 through a molding process. Notably, the antenna housing 130 is coupled with the cellular phone not in a screw manner, currently much used in the art, but in a snap manner.

In the case where the antenna housing 130 is mounted to the bottom surface of the cellular phone, a calculated SAR is on the order of 0.15W/kg, from which it can be seen that the amount of electromagnetic waves absorbed by the human head is reduced by up to 90% or more compared to the existing cellular phones. The reason is that the antennas when the antenna housing 130 is mounted to the bottom surface of the cellular phone are apart at a longer distance from the human head than those when the antenna housing 130 is mounted to the top surface of the cellular phone.

On the other hand, a projection (not shown) is externally formed on the rear surface of the antenna housing 130 such that a user does not grasp the projection and the surrounding portion with his or her hand while using the cellular phone.

The antenna module of the present invention can be manufactured in consideration of the SAR (1.6 W/kg(1g average)) limits imposed by FCC in U.S.A., which is the strictest standard throughout the world. Calculating the SAR with the manufactured antenna module, the result is 0.25 W/kg, a reduction of 76% to 86% compared to those of the existing cellular phones (1.1-1.8 W/kg). From this fact, it can be seen that the effect of cellular phone electromagnetic radiation on the human body can be reduced by a considerable degree. Further, the use of the two helix antennas 100 can increase the maximum antenna gain by about 2 dB and, in turn, the quality of speech of the cellular phone by 50% or more compared to those of the existing cellular phones.

Moreover, the present antenna module can be actually manufactured such that it is not externally visible. A small projection is formed on the boundary between the antenna module and the cellular phone body at the rear part of the cellular phone such that a user does not grasp the projection and the surrounding portion with his or her hand while using the cellular phone. As a result, this projection has the effect of preventing a degradation in speech quality resulting from a situation where the user grasps the antenna module with his or her hand due to the small size of the cellular phone while using the cellular phone.

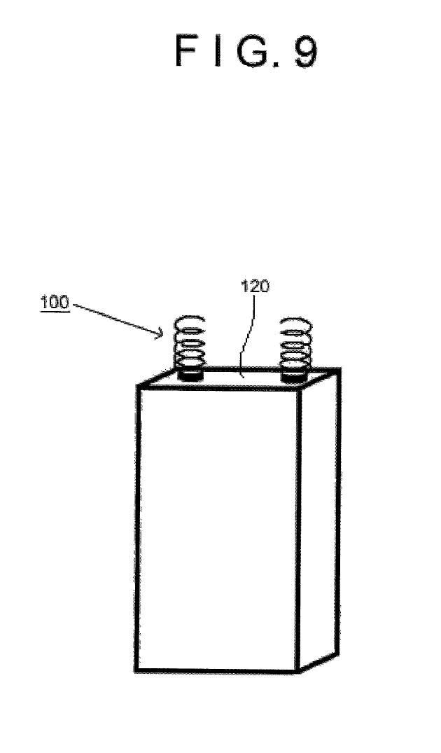

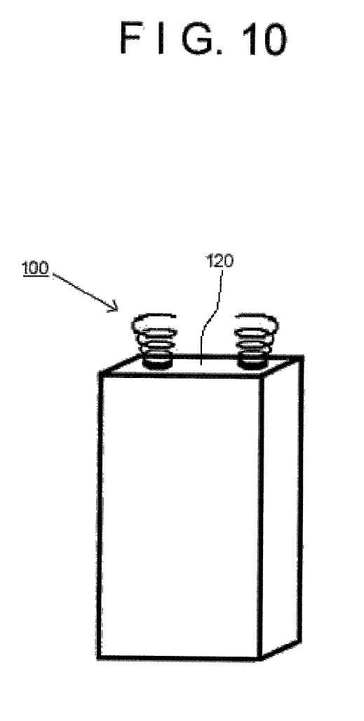

On the other hand, each of the helix antennas 100 may have a pitch gradually enlarging from the bottom of the antenna to the top thereof as shown in FIG. 9 or a radius gradually increasing from the bottom of the antenna to the top thereof as shown in FIG. 10, thereby enlarging a frequency bandwidth of the antenna. In this case, the other constructions of the helix antennas 100 are the same as the above-described constructions.

The wideband helix antenna module as shown in FIG. 9 or FIG. 10 is installable on the bottom surface of the cellular phone as well as the top surface thereof, in a similar manner to the previously stated helix antenna module.

The above wideband helix antenna module is applicable to an image service requiring a much wider bandwidth than the existing antennas as well as to a voice or character service.

### <EMBODIMENT 2>

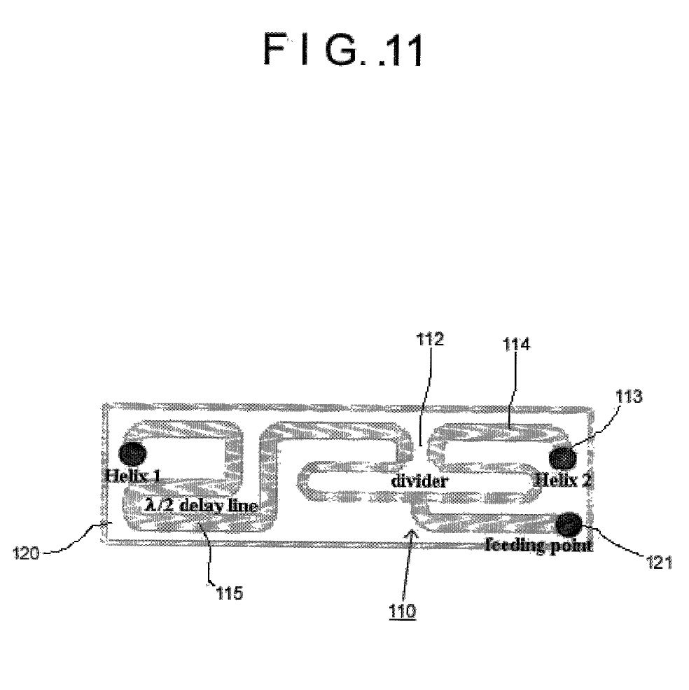

In a second embodiment of the present invention, as shown in FIGS. 11 to 13, a power signal of 50Ω is applied to a feeding point 121 on a PCB 120 and then matched with two helix antennas 100 with the same shape and the same helical direction at opposite phases. To this end, the two helix antennas 100 and a power supply unit 110 are used.

The two helix antennas 100 may preferably have the same radiation pattern as that of FIG. 2. The power supply unit 110 is used to form the same radiation pattern as that of FIG. 2.

The power supply unit 110 basically includes a divider 112, two transmission lines 114, a λ/2 delay line 115 and two helix couplers 113 formed on the PCB 120 as shown in FIG. 11. The helix antennas 100 are coupled respectively with the helix couplers 113.

The divider 112 is installed in a predetermined portion of the PCB 120 and electrically connected to the feeding point 121 formed on the PCB 120. The feeding point 121 is connected to a feeding point of a cellular phone to receive the power signal of 50Ωtherefrom. The power signal applied to the feeding point 121 is fed to the divider 112, which then divides it equally and supplies the resulting two power signals respectively to the two transmission lines 114, as will be described later.

The two transmission lines 114 are connected to the divider 112 and divided by it in such a manner that one thereof is connected to the λ/2 delay line 115 at its end and the other is connected directly to the associated helix coupler 113 at its end. The λ/2 delay line 115 is connected to the associated transmission line 114 at its one end and to the associated helix coupler 113 at its other end. As a result, one of the power signals divided by the divider 12 is transmitted directly to the associated helix coupler 113 through the associated transmission line 114 and the other power signal is transmitted to another helix coupler 113 through another transmission line 114 and the λ/2 delay line 115. Hence, the power signals applied to the helix antennas 100 via the helix couplers 113 have the same current flow direction but a path difference corresponding to λ/2.

Accordingly, because the two helix antennas 100 have the same helical direction, their equivalent structures can be interpreted to have successive arrays of loop antennas 101 and dipole antennas 102. In this regard, the current flow directions of the loop antennas 101 and dipole antennas 102 of the two helix antennas 100 are the same, but the phases of the power signals applied to the helix antennas 100 are opposite to each other according to the operation of the λ/2 delay line 115. As a result, in the case where the PCB 120 having the two helix antennas 100 is mounted to the cellular phone, because radiation components of the dipole antennas 102 of the two helix antennas 100 have a path difference of λ/2 therebetween, they offset each other in the longitudinal direction of the cellular phone between the helix antennas 100, or toward the top or rear part of the cellular phone, and overlap each other in the transversal direction of the cellular phone between the helix antennas 100, as shown in FIG. 6. Also, because radiation components of the loop antennas 101 of the two helix antennas 100 have the same radiation direction, they overlap each other between the helix antennas 100 so as to generate a strong electromagnetic field, thereby enhancing the quality of speech. Notably, the same amount of power must be supplied to the two helix antennas 100. This can be realized by applying the power signals with the same power level respectively to the helix antennas 100 under the control of the divider 112.

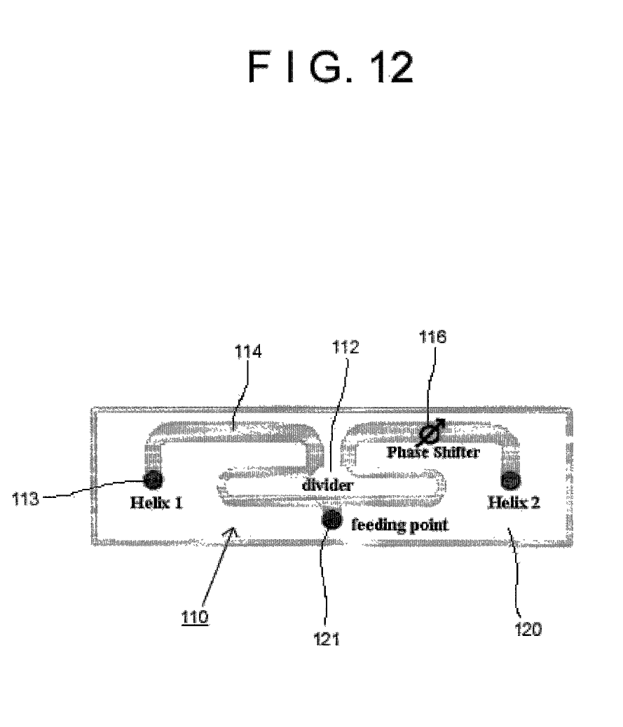

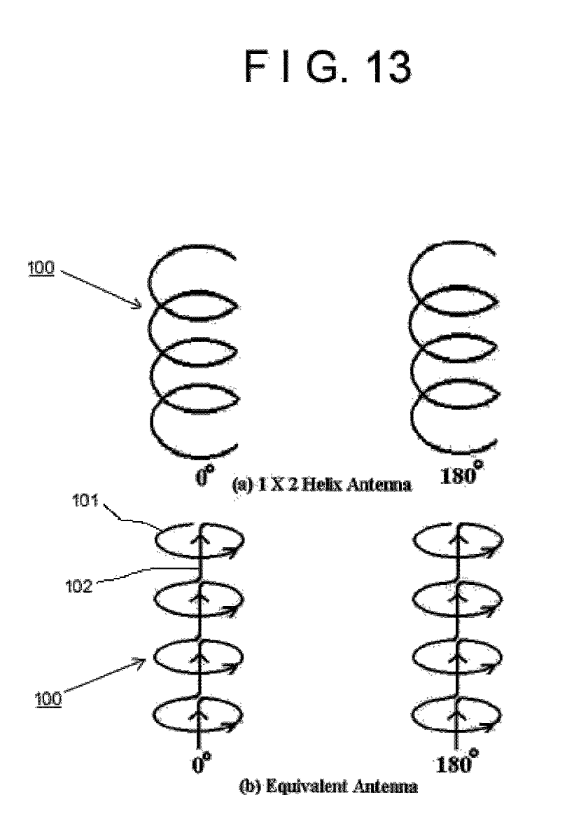

In the construction of FIG. 11, the λ/2 delay line 115 is used as the phase control means. As an alternative, a phase shifter 116 may be used as the phase control means instead of the λ/2 delay line 115, as shown in FIG. 12, in order to obtain the same result. Namely, when using the phase shifter 116 instead of the λ/2 delay line 115 as shown in FIG. 12, the current flow directions of the loop antennas 101 and dipole antennas 102 of the two helix antennas 100 are the same, but the power signals applied to the helix antennas 100 have a path difference of λ/2 therebetween according to the operation of the phase shifter 116, as shown in FIG. 13, thereby generating the same electromagnetic radiation pattern as that based on the λ/2 delay line 115 as shown in FIG. 6.

In other words, as stated above, the helix antennas 100 radiate electromagnetic waves in response to the power signals from the helix couplers 113 and thus generate an electromagnetic radiation pattern as shown in FIG. 6 where electromagnetic waves offset each other at the front part or rear part of the cellular phone and increase in amount in the transversal direction of the cellular phone.

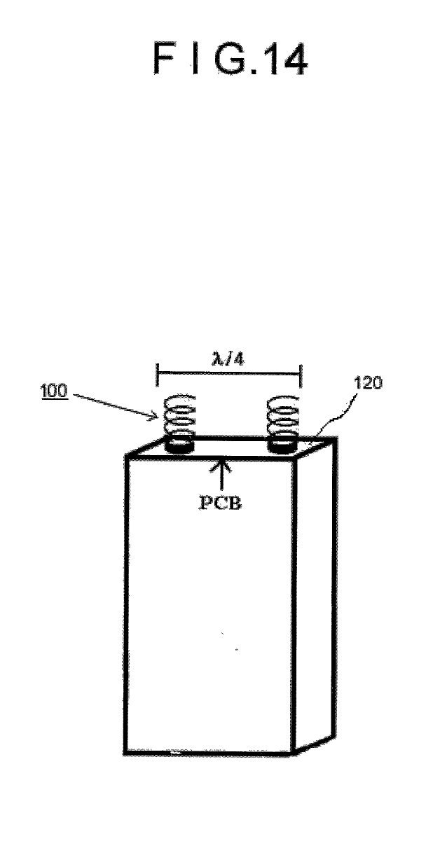

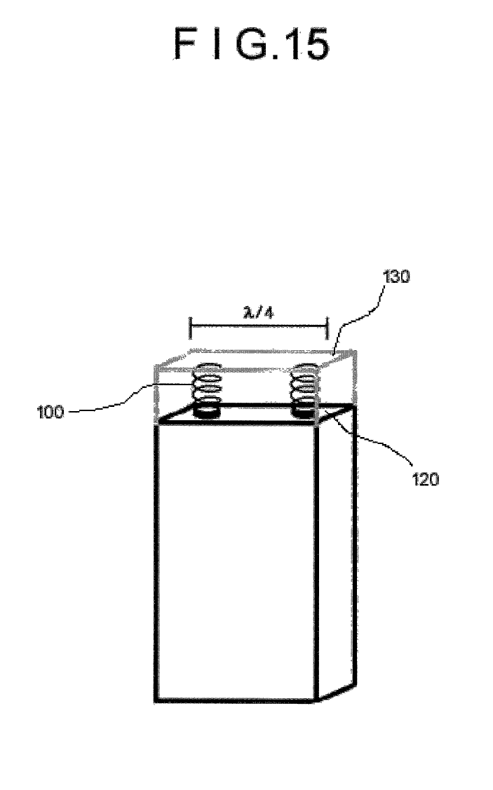

The PCB 120 can be coupled with the cellular phone by connecting its feeding point to a feeding point of the cellular phone. Namely, the PCB 120 can be closely mounted to the top surface or bottom surface of the cellular phone as shown in FIG. 14. Alternatively, the PCB 120 having the helix antennas 100 installed therein may be integrated with an antenna housing 130 through a molding process and the antenna housing 130 may thereafter be mounted to the top surface or bottom surface of the cellular phone, as shown in FIG. 15.

Namely, the PCB 120 equipped with the helix antennas 100 is mounted to the top surface or bottom surface of the cellular phone under the condition that it is integrated with the antenna housing 130 through a molding process. Preferably, the antenna housing 130 is coupled with the cellular phone not in a screw manner, currently much used in the art, but in a snap manner. In the case where the antenna housing 130 is mounted to the bottom surface of the cellular phone, a calculated SAR is on the order of 0.15 W/kg as in the first embodiment, from which it can be seen that the amount of electromagnetic waves absorbed by the human head is reduced by up to 90% or more compared to the existing cellular phones.

Similarly to the first embodiment, a projection (not shown) is externally formed on the rear surface of the antenna housing 130 such that a user does not grasp the projection and the surrounding portion with his or her hand while using the cellular phone.

Calculating the SAR with the antenna module of the present invention manufactured in the above manner, the result is 0.25 W/kg, a reduction of 76% to 86% compared to those of the existing cellular phones (1.1-1.8 W/kg), which is the same result as the first embodiment. From this fact, it can be seen that the effect of cellular phone electromagnetic radiation on the human body can be reduced by a considerable degree. Further, the use of the two helix antennas 100 can increase the maximum antenna gain by about 2 dB and, in turn, the quality of speech of the cellular phone by 50% or more compared to those of the existing cellular phones.

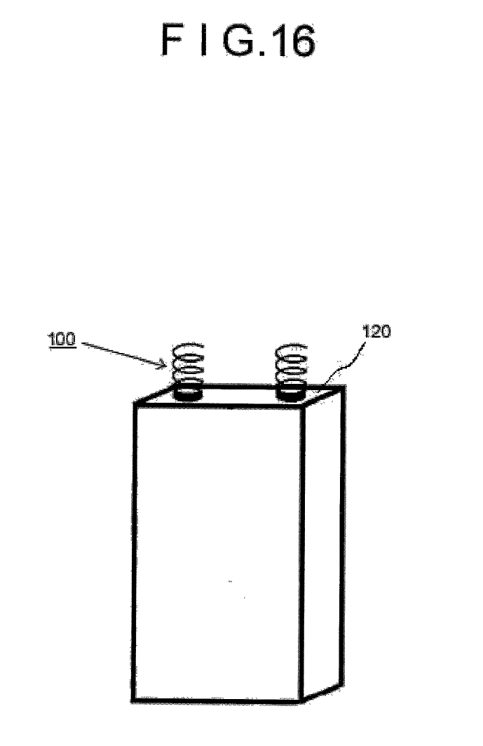

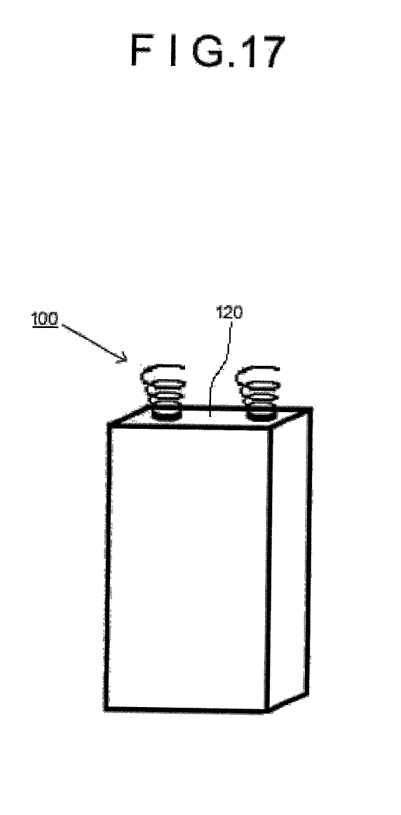

On the other hand, each of the helix antennas 100 may have a pitch gradually enlarging from the bottom of the antenna to the top thereof as shown in FIG. 16 or a radius gradually increasing from the bottom of the antenna to the top thereof as shown in FIG. 17, thereby enlarging a frequency bandwidth of the antenna as in the first embodiment. In this case, the other constructions of the helix antennas 100 are the same as the above-described constructions.

The wideband helix antenna module as shown in FIG. 16 or FIG. 17 is installable on the bottom surface of the cellular phone as well as the top surface thereof, in a similar manner to the first embodiment. Also, this helix antenna module is applicable to an image service requiring a much wider bandwidth than the existing antennas as well as to a voice or character service.

### EMBODIMENT 3

In a third embodiment of the present invention, as shown in FIGS. 11, 12 and 18, a power signal of 50Ωis applied to a feeding point 121 on a PCB 120 and then matched with two helix antennas 100 with the same shape and opposite helical directions at opposite phases. To this end, the two helix antennas 100 and a power supply unit 110 are used. Namely, the shape of the helix antennas in the third embodiment is the same as that in the first embodiment and the power supply unit in the third embodiment is the same in construction and operation as the second embodiment.

In FIG. 11, the power supply unit 110 basically includes a divider 112, two transmission lines 114, a λ/2 delay line 115 and two helix couplers 113 formed on the PCB 120, as in the second embodiment. The helix antennas 100 are coupled respectively with the helix couplers 113.

The divider 112 is installed in a predetermined portion of the PCB 120 and electrically connected to the feeding point 121. The feeding point 121 is connected to a feeding point of a cellular phone to receive the power signal of 50Ωtherefrom. The power signal applied to the feeding point 121 is fed to the divider 112, which then divides it equally and supplies the resulting two power signals respectively to the two transmission lines 114, as will be described later.

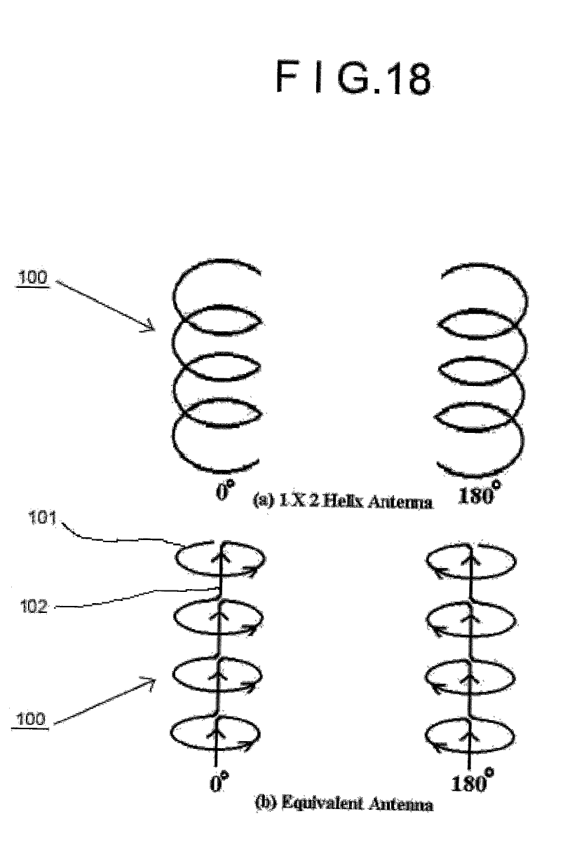

The two transmission lines 114 are connected to the divider 112 and divided by it in such a manner that one thereof is connected to the λ/2 delay line 115 at its end and the other is connected directly to the associated helix coupler 113 at its end. The λ/2 delay line 115 is connected to the associated transmission line 114 at its one end and to the associated helix coupler 113 at its other end. As a result, one of the power signals divided by the divider 12 is transmitted directly to the associated helix coupler 113 through the associated transmission line 114 and the other power signal is transmitted to another helix coupler 113 through another transmission line 114 and the λ/2 delay line 115. Hence, the power signals applied to the helix antennas 100 via the helix couplers 113 have a path difference of λ/2 as shown in FIG. 18.

Therefore, because the two helix antennas 100 have opposite helical directions, their equivalent structures can be interpreted to have successive arrays of loop antennas 101 and dipole antennas 102. In this regard, the current flow directions of the loop antennas 101 of the two helix antennas 100 are opposite to each other whereas the current flow directions of the dipole antennas 102 of the two helix antennas 100 are the same. Also, the phases of the power signals applied to the helix antennas 100 are opposite to each other according to the operation of the λ/2 delay line 115. As a result, in the case where the PCB 120 having the two helix antennas 100 is mounted to the cellular phone, radiation components of the dipole antennas 102 of the two helix antennas 100 offset each other between the helix antennas 100 because they have a path difference of λ/2 therebetween. Similarly, because the current flow directions of the loop antennas 101 of the two helix antennas 100 are opposite to each other, radiation components of the loop antennas 101 offset each other between the helix antennas 100.

Consequently, the radiation components of the two helix antennas 100 offset each other in the longitudinal direction of the cellular phone, or toward the top or rear part of the cellular phone, whereas they overlap each other in the transversal direction of the cellular phone, as shown in FIG. 6. Also, the same amount of power must be supplied to the two helix antennas 100. This can be realized by applying the power signals with the same power level respectively to the helix antennas 100 under the control of the divider 112.

In the construction of FIG. 11, the λ/2 delay line 115 is used as the phase control means. As an alternative, a phase shifter 116 may be used as the phase control means instead of the λ/2 delay line 115, as shown in FIG. 12, in order to obtain the same result. Namely, for the use of the phase shifter 116 instead of the λ/2 delay line 115 as shown in FIG. 12, the current flow directions of the loop antennas 101 of the two helix antennas 100 are opposite to each other whereas the current flow directions of the dipole antennas 102 of the two helix antennas 100 are the same, but the power signals applied to the helix antennas 100 have a path difference of λ/2 therebetween according to the operation of the phase shifter 116, as shown in FIG. 6, thereby generating the same electromagnetic radiation pattern as that based on the λ/2 delay line 115 as shown in FIG. 6.

In brief, as stated above, the helix antennas 100 radiate electromagnetic waves in response to the power signals from the helix couplers 113 and thus generate an electromagnetic radiation pattern as shown in FIG. 6 where electromagnetic waves offset each other at the front part or rear part of the cellular phone and increase in amount in the transversal direction of the cellular phone.

The PCB 120 can be coupled with the cellular phone by connecting its feeding point 121 to a feeding point of the cellular phone. Namely, the PCB 120 can be closely mounted to the top surface or bottom surface of the cellular phone as shown in FIG. 7. Alternatively, the PCB 120 having the helix antennas 100 installed therein may be integrated with an antenna housing 130 through a molding process and the antenna housing 130 may thereafter be mounted to the top surface or bottom surface of the cellular phone, as shown in FIG. 8.

Namely, the PCB 120 equipped with the helix antennas 100 is mounted to the top surface or bottom surface of the cellular phone under the condition that it is integrated with the antenna housing 130 through a molding process. Preferably, the antenna housing 130 is coupled with the cellular phone in a snap manner as in the first embodiment.

In the case where the antenna housing 130 is mounted to the bottom surface of the cellular phone, a calculated SAR is on the order of 0.15 W/kg as in the first embodiment, from which it can be seen that the amount of electromagnetic waves absorbed by the human head is reduced by up to 90% or more compared to the existing cellular phones. The reason is that the antennas when the antenna housing 130 is mounted to the bottom surface of the cellular phone are apart at a longer distance from the human head than those when the antenna housing 130 is mounted to the top surface of the cellular phone.

Similarly to the first embodiment, a projection (not shown) is externally formed on the rear surface of the antenna housing 130 such that a user does not grasp the projection and the surrounding portion with his or her hand while using the cellular phone.

Calculating the SAR with the antenna module of the present invention manufactured in the above manner, the result is 0.25 W/kg, a reduction of 76% to 86% compared to those of the existing cellular phones (1.1-1.8 W/kg), which is the same result as the first embodiment. From this fact, it can be seen that the effect of cellular phone electromagnetic radiation on the human body can be reduced by a considerable degree. Further, the use of the two helix antennas 100 can increase the maximum antenna gain by about 2 dB and, in turn, the quality of speech of the cellular phone by 50% or more compared to those of the existing cellular phones.

On the other hand, each of the helix antennas 100 may have a pitch gradually enlarging from the bottom of the antenna to the top thereof as shown in FIG. 9 or a radius gradually increasing from the bottom of the antenna to the top thereof as shown in FIG. 10, thereby enlarging a frequency bandwidth of the antenna as in the first embodiment. In this case, the other constructions of the helix antennas 100 are the same as the above-described constructions.

The wideband helix antenna module as shown in FIG. 9 or FIG. 10 is installable on the bottom surface of the cellular phone as well as the top surface thereof, in a similar manner to the first embodiment. Also, this helix antenna module is applicable to an image service requiring a much wider bandwidth than the existing antennas as well as to a voice or character service.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An antenna module for a cellular phone, comprising:
two helix antennas installed in the cellular phone transversally apart from each other; and
power supply means connected to said helix antennas for applying two power signals respectively to said helix antennas, said power signals having the same power level and opposite phases.

2. The antenna module as set forth in claim 1, wherein said helix antennas have opposite helical directions such that they have opposite phases while remaining matched with each other.

3. The antenna module as set forth in claim 1, wherein said helix antennas have the same helical direction.

4. The antenna module as set forth in claim 1 or claim 2, wherein said power supply means includes:
a divider for receiving a power signal from a feeding point and dividing it equally into said two power signals in two different directions;
two transmission lines divided by said divider in said two different directions for transmitting said two power signals from said divider respectively to said two helical antennas; and
two helix couplers formed respectively at ends of said two transmission lines and coupled respectively with said two helix antennas for applying said two power signals transmitted respectively over said two transmission lines respectively to said two helix antennas.

5. The antenna module as set forth in claim 4, wherein said two transmission lines are symmetrical with each other.

6. The antenna module as set forth in any one of claim 1 to claim 3, wherein said power supply means includes:
a divider for receiving a power signal from a feeding point and dividing it equally into said two power signals in two different directions;
two transmission lines divided by said divider in said two different directions for transmitting said two power signals from said divider respectively to said two helical antennas; and
a λ/2 delay line or phase shifter connected to one of said two transmission lines for delaying a phase of said power signal transmitted over the connected transmission line.

7. The antenna module as set forth in claim 4 or claim 6, wherein said power supply means is formed on a printed circuit board.

8. The antenna module as set forth in claim 7, wherein said printed circuit board is mounted to an antenna housing through a molding process under the condition that it is coupled with said helix antennas.

9. The antenna module as set forth in claim 8, wherein said antenna housing is mounted to any one of a top surface or bottom surface of said cellular phone.

10. The antenna module as set forth in claim 8 or claim 9, wherein said antenna housing has a projection formed on its rear surface such that a user does not grasp said antenna housing with his or her hand.

11. The antenna module as set forth in any one of claim 1 to claim 3, wherein each of said helix antennas has a pitch gradually enlarging outward from said cellular phone.

12. The antenna module as set forth in any one of claim 1 to claim 3, wherein each of said helix antennas has a radius gradually increasing outward said cellular phone.

13. An antenna module for a cellular phone having two helix antennas wherein said helix antennas are installed in the cellular phone transversally apart from each other, have opposite helical directions such that they have opposite phases while remaining matched with each other and are connected to power supply means to receive the same amount of power therefrom.

14. An antenna module for a cellular phone, comprising:
two helix antennas installed in the cellular phone transversally apart from each other and having the same helical direction; and
power supply means connected to said helix antennas for applying two power signals respectively to said helix antennas, said power signals having the same power level and opposite phases.

15. An antenna module for a cellular phone, comprising:
two helix antennas, each having an equivalent structure composed of successive combinations of loop antennas and dipole antennas, said helix antennas installed in the cellular phone transversally apart from each other and having opposite helical directions such that the current flow directions of said loop antennas of said helix antennas are opposite to each other; and
power supply means connected to said helix antennas for applying two power signals respectively to said helix antennas, said power signals having the same power level and opposite phases.
